(19) United States
(12) Patent Application Publication
(10) Pub. No.: US 2024/0400319 A1
(43) Pub. Date: Dec. 5, 2024

(54) AUGER SYSTEMS FOR REDUCING GRAIN BIN ENTRAPMENT

(71) Applicant: Gahler Innovations LLC, Pierz, MN (US)

(72) Inventor: Mason Gahler, Pierz, MN (US)

(21) Appl. No.: 18/771,812

(22) Filed: Jul. 12, 2024

Related U.S. Application Data
(63) Continuation-in-part of application No. 18/506,712, filed on Nov. 10, 2023, now Pat. No. 12,058,963.
(60) Provisional application No. 63/497,571, filed on Apr. 21, 2023.

(51) Int. Cl. B65G 65/36; B65G 65/38; B65G 69/08

(52) U.S. Cl. CPC B65G 65/365; B65G 65/38; B65G 69/08; B65G 2201/042

(57) ABSTRACT

A system may include a first casing housing a first auger, wherein a longitudinal axis of the first auger is configured to be positioned substantially parallel to a floor of the grain bin, and a second casing housing a second auger, wherein a longitudinal axis of the second auger is configured to be positioned substantially perpendicular to the longitudinal axis of the first auger. A system may include a first gearbox operatively coupled to the first auger and the second auger, torsionally locking the first auger and the second auger to one another, wherein the first auger is configured to convey grain along the longitudinal axis of the first auger to the second auger, and wherein the second auger is configured to convey grain from the first auger to a top portion of the grain bin along the longitudinal axis of the second auger.

### CROSS-REFERENCE TO RELATED APPLICATIONS

This application is a continuation-in-part of U.S. Nonprovisional patent application Ser. No. 18/506,712, filed Nov. 10, 2023, which claims the priority benefit of U.S. Provisional Patent Application Ser. No. 63/497,571, filed Apr. 21, 2023, the contents of each of which are herein incorporated by reference in their entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of agriculture, and more specifically to the fields of safety equipment in agriculture and grain drying. Described herein are systems and methods for reducing grain bin entrapment.

### BACKGROUND

Grain bin entrapment is a serious occupational hazard in the agriculture industry, which can lead to fatalities. The leading cause of death in grain bins is suffocation caused by engulfment in grain. Other contributing factors include lack of proper safety equipment, inadequate training, and failure to follow safety protocols. Engulfment in grain occurs when an individual is buried in grain and cannot breathe due to the pressure on their chest, resulting in suffocation. Conventional methods of addressing grain bin entrapment include safety measures, such as wearing safety harnesses and using lockout/tag-out procedures. Education and training have also been used to reduce the risk of grain bin entrapment and fatalities in the agriculture industry.

However, despite these conventional measures being in place, Purdue University recently published a study in April 2022 showing that the number of non-fatal grain entrapment cases in 2021 was the fifth largest ever recorded. Of the reported entrapment cases in 2021, 38% resulted in a fatality, a rate higher than the five-year average. Said another way, number of people dying in grain bins can range from 20 to 40 deaths per year in the U.S. alone. This number is growing because bins are getting larger with more holding capacity.

Accordingly, there exists a need for new and improved devices and methods for reducing grain bin entrapment.

### SUMMARY

In some aspects, the techniques described herein relate to a system for reducing grain attachment to a sidewall of a grain bin, including: a first casing housing a first auger, wherein a longitudinal axis of the first auger is configured to be positioned substantially parallel to a floor of the grain bin and offset from the floor of the grain bin, wherein the first casing is a trough casing or a perforated casing; a second casing housing a second auger, wherein a longitudinal axis of the second auger is configured to be positioned substantially perpendicular to the longitudinal axis of the first auger; and a first gearbox operatively coupled to the first auger and the second auger, torsionally locking the first auger and the second auger to one another, wherein the first gearbox is configured to be positioned closer to the sidewall of the grain bin than a centroid of the grain bin, wherein the first auger is configured to convey grain along the longitudinal axis of the first auger to the second auger, and wherein the second auger is configured to convey grain from the first auger to a top portion of the grain bin along the longitudinal axis of the second auger.

In some aspects, the techniques described herein relate to a system for reducing grain attachment to a sidewall of a grain bin, including: a first casing housing a first auger, wherein a longitudinal axis of the first auger is configured to be positioned substantially parallel to a floor of the grain bin and offset from the floor of the grain bin, wherein the first casing is a trough casing or a perforated casing; a second casing housing a second auger, wherein a longitudinal axis of the second auger is configured to be positioned substantially parallel to a floor of the grain bin and offset from the floor of the grain bin, wherein the second casing is a trough casing or a perforated casing, wherein the first auger and the second auger are separated by a first angle; a third casing housing a third auger, wherein a longitudinal axis of the third auger is configured to be positioned substantially perpendicular to the longitudinal axis of the first auger and the longitudinal axis of the second auger; and a first gearbox operatively coupled to the first auger, the second auger, and the third auger, wherein the first, second, and third augers are torsionally locked to one another, wherein the first auger and the second auger are configured to convey grain along the longitudinal axis of the first auger and the longitudinal axis of the second auger, respectively, to the third auger, and wherein the third auger is configured to convey grain from the first auger and the second auger to a top portion of the grain bin along the longitudinal axis of the third auger.

In some aspects, the techniques described herein relate to a method of reducing grain attachment to a sidewall of a grain bin, including: positioning a first gearbox closer to the sidewall of the grain bin than to a centroid of the grain bin; operatively coupling a first auger housed within a first casing to the first gearbox, wherein a longitudinal axis of the first auger is positioned substantially parallel to a floor of the grain bin and offset from the floor of the grain bin, wherein the first casing is a trough casing or a perforated casing; operatively coupling a second auger housed within a second casing to the first gearbox, wherein a longitudinal axis of the second auger is configured to be positioned substantially perpendicular to the longitudinal axis of the first auger, wherein the longitudinal axis of the second auger is configured to extend from a bottom portion of the grain bin to a top portion of the grain bin; and providing a power source that, when activated, is configured to rotate the first auger and the second auger that is torsionally locked to the first auger via the first gearbox; wherein the grain is configured to be conveyed along the longitudinal axis of the first auger to the second auger, and conveyed by the second auger from the bottom portion of the grain bin to the top portion of the grain bin.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates an embodiment of a system for reducing bin entrapment.

FIG. 2 illustrates a transparent view of a bin including an embodiment of a device for reducing bin entrapment installed therein.

FIG. 3 illustrates an embodiment of a bin including an embodiment of a device for reducing entrapment installed therein.

FIG. 4 illustrates an embodiment of a bin including an embodiment of a device for reducing entrapment installed therein.

FIG. 5 illustrates an embodiment of a method for reducing bin entrapment.

FIG. 6 illustrates a bin and the possible effects on stored grain when unloading with a traditional system.

FIG. 7 illustrates an embodiment of a bin including an embodiment of a device for reducing entrapment installed therein including two auger assemblies.

FIG. 8 illustrates a sweep auger assembly known in the art within a bin.

FIG. 9 illustrates the possible effects on grain stored in a grain bin and unloaded with a traditional system.

FIG. 10 illustrates a system of augers for reducing bin entrapment.

FIG. 11 illustrates a top view perspective of the system of FIG. 10 within a grain bin.

FIG. 12 illustrates a gathering bin of the system of FIGS. 10-11.

FIG. 13 illustrates an embodiment of a system of augers for reducing grain bin entrapment.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Disclosed herein are systems, devices, and methods for increasing grain flow in a grain bin, rotating a substantial portion of the volume of grain stored in a grain bin, reducing an amount of grain stuck or attached to a sidewall of a grain bin, reducing moisture-related spoilage, and/or reducing grain bin entrapment. Described herein are systems and devices that function to rotate (i.e., circulate) the grain, so it doesn't mold, clump, and/or spoil. When grain is put in a bin, it can become spoiled, which can cause the grain to stop flowing while being unloaded. It is dangerous when the farmer goes into the bin to get the grain to flow again. If the flow restarts or continues while the farmer is still in the bin, the grain could collapse and engulf the farmer causing serious injury or death.

Although the various embodiments described herein are described with respect to a grain bin, one of skill in the art will appreciate that any material may be conveyed using the systems, devices, and methods described herein. For example, materials may include grain, fertilizer, compost, feed, manure, soil, salt, sand, etc.

When storing contents (e.g., grain) in bins, moisture is a major concern for reducing spoilage, allowing efficient transfer of contents from within the bin, and reducing grain bin entrapment, during long-term storage of contents. For example, grain may be loaded into storage bins with a considerably greater moisture content than the grain when it is unloaded after long-term storage. As such, moisture migrates from the grain and exits the bin to the environment surrounding the bin. In this process, moisture may condense (when conditions allow) to the inner sidewall of the grain bin. Condensation, including on the inner sidewall of the grain bin, is a major cause of grain spoilage near the inner sidewall, the clumping of grain near the sidewall of the grain bin, the sticking of grain to the inner sidewall of the grain bin, and, thus, grain bin entrapment. To reduce these effects, circulation of the grain (or other contents) may be used to reduce build-up of moisture in the grain near the sidewall of the grain bin. Additionally, circulation of bin contents reduces the ingress moisture effects if the bin includes areas with insufficient ingress protection (e.g., leaks, damaged portions, weather-damaged gaskets, or the like). For any of the embodiments described herein, material (e.g., grain, fertilizer, manure, soil, etc.) from a bottom portion or region of the bin gets circulated to a top portion or region of the bin, which helps dry the material, reduce clumping (especially to sidewalls of the bin), and reduces the need for individuals to enter the bin.

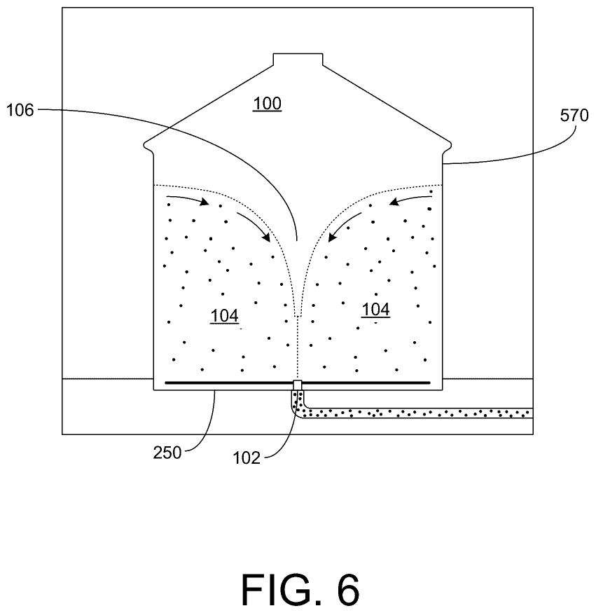

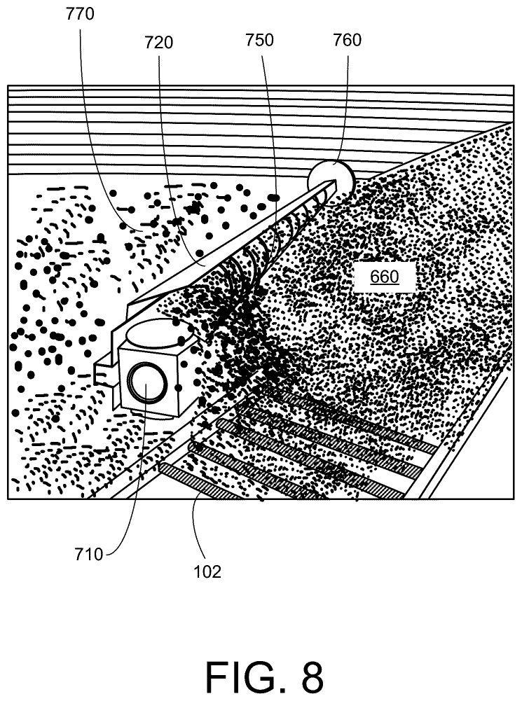

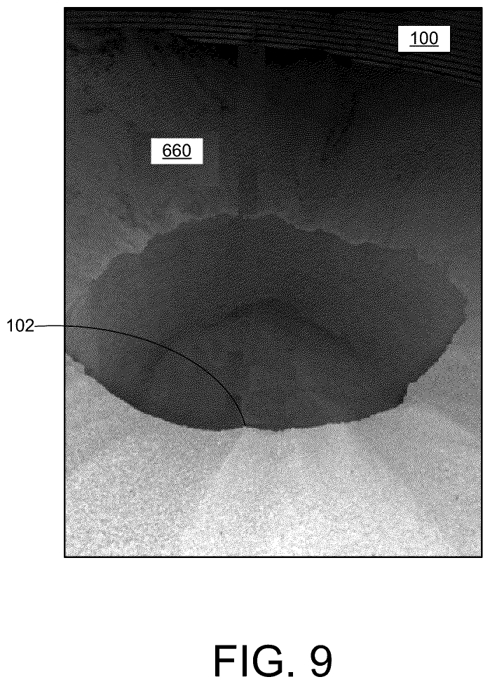

Material (e.g., grain, fertilizer, manure, soil, etc.) stored in a bin may experience extended periods of inactivity (i.e., no loading or unloading of material). As such, the extended inactivity periods introduce conditions that may cause spoilage, clumping, and sticking of material as the material remains static. As shown in FIG. 6, conventional systems used on flat bottom bins unload from a sump 102 in the center of the bin 100, and, as such, gravity forces material to the sump 102 of the bin 100 in a conical fashion (illustrated by the cone area 106). Material in area 104 between the sidewall 270 of the bin 100 and the material in the cone area 106 being fed to the sump 102 may remain static even during unloading of the bin. Conventional systems may be paired with a sweep auger assembly 770 (shown in FIG. 8) to help transfer material in area 104 between the sidewall of the bin and the material of the cone area 106 being fed to the sump 102, but the sweep auger assembly 770 is typically only used after gravity has driven all the material in the cone area 106 into the sump 102. Additionally, sweep augers are typically only used during active unloading periods. As shown in FIG. 8, the sweep auger assembly 770 includes a sweep auger 750, a partial housing 720, a power source 710 (e.g., a gearbox), and a wheel 760. The sweep auger 750, when driven by the power source 710, transfers grain to the sump 102. The wheel 760 being coupled to the auger 750 is rotated and drives the assembly 770 toward the remaining grain 660. When contacted by the auger 750, partially surrounded by the housing 720, the grain 660 is transferred toward the sump 102. Contact of the auger 750 and the grain 660 is ensured by the wheel 760 rotating toward the grain 660. After the gravity driven material in the cone area 106 has been unloaded, the effects (e.g., the clumping of grain near the sidewall of the grain bin, the sticking of grain to the inner sidewall of the grain bin, and, thus, grain bin entrapment when a person goes into the bin to remove the grain from the sidewalls) of the material remaining static may have already occurred. Conventional systems that include volume circulation systems may only provide circulation when the bin 100 is actively being unloaded and may only gather material (e.g., grain 660) from the position of the sump 102 (i.e., the center of the bin). As such, conventional systems do not address the static material state during periods of inactivity or provide circulation for material in the area 104 between the sidewall 270 of the bin 100 and the gravity-driven cone area 106. FIG. 9 shows the inside of a bin equipped with only a traditional unloading system. FIG. 9 shows uncirculated (i.e., static) grain 660 that has stuck together forming a cohesive form in which the grain 660 will no longer migrate toward the sump 102. The cohesive grain 660 structure occurs in the uncirculated area 104 (shown in FIG. 6). Cohesive grain 660, as shown in FIG. 9, includes a high probability of entrapment.

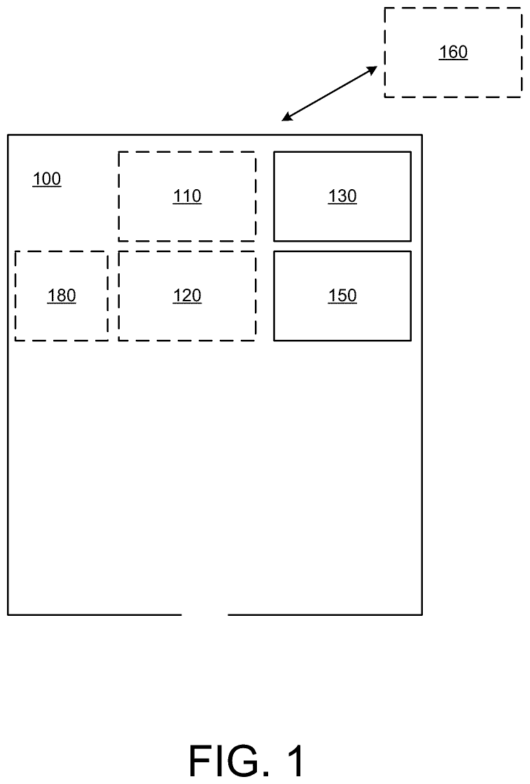

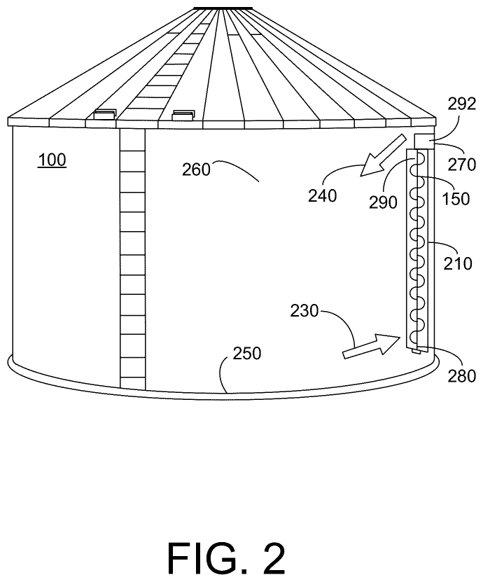

The systems and methods described herein solve the above problems. For example, as shown in FIGS. 1-2, various embodiments of systems and devices of reducing grain bin entrapment include a power source 130 and an auger 150 attachable to at least a portion of an inner sidewall 270 of a grain bin 100. For example, a casing 210 housing the auger 150 may be attached to at least a portion of an inner sidewall 270 of the grain bin 100. As shown in FIG. 1, a system may further optionally include optional control circuitry 110, an optional antenna 120, one or more optional sensors 180, and an optional computing device 160 communicatively coupled (e.g., Wi-Fi®, LTE, Bluetooth, cellular, etc.) to the optional control circuitry 110 via optional antenna 120.

As shown in FIGS. 1-2, an auger 150 is a type of screw conveyor used to move materials such as grain, feed, or fertilizer horizontally, vertically, or at any angle therebetween. An auger includes a rotating helical screw blade, also known as a flighting, that is contained within a tube or casing 210. When the auger 150 is activated using power source 130, the helical blade rotates and moves the material along the length of the tube or casing 210. For example, the helical blade may move or convey grain, feed, or fertilizer from a bottom portion 250 of a grain bin 100 to a top portion 260 of the grain bin 100 causing circulation of bin 100 contents. The pitch of the helical blade, or the distance between the threads, determines the amount of material that is moved with each revolution of the blade. In a vertical auger 150, as shown in FIG. 2, the material is lifted or conveyed from a bottom end 280 of the auger 150 using power from the power source 130, for example a motorized pulley, an electric motor, a hydraulic system, an engine (e.g., variable speed engine), or other power system, and then distributed, released, or otherwise exits a top end 290 or discharge end of the auger 150. The power source 130 may be hardwired into an electrical box for the bin 100, may include one or more batteries for storing solar energy from one or more solar panels coupled to the bin 100, or the like. Further for example, arrow 230 shows the movement of material into a bottom end 280 of the auger 150 and arrow 240 shows the exiting of material at a top end 290 of the auger 150. Not limiting examples of augers that may be used include Westfield augers or Rigid augers.

A casing 210 housing the auger 150 is coupled to at least a portion of a sidewall 270 of the bin 100 by one or more coupling elements 292. One or more coupling elements 292 may include bolts, screws, straps, and the like. For example, one or more metal straps may be used along the length of the casing 210 to secure the casing 210 to the sidewall 270 of the bin 100. In some embodiments, the coupling between the casing 210 and at least a portion of the sidewall 270 of the bin 100 is positioned so that the power source 130 and/or transmission elements (e.g., belts, chains, or the like) are above the material in the bin 100.

One of skill in the art will appreciate that augers can vary in size and configuration depending on the application. As such, one of skill in the art will appreciate that any size of auger can be used herein, for example depending on the material being conveyed, a volume of the bin in which the material is stored, a desired flow of material in the bin, and the like. In some embodiments, a number of augers to be installed is determined based on a volume of the grain bin or a number of bushels a grain bin can store. For example, grain bins may store from about 800 bushels to about 2,500 bushels, from about 2,500 bushels to about 5,000 bushels, from about 5,000 to about 7,500 bushels, from about 7,500 bushels to about 11,000 bushels, from about 11,000 bushels to about 15,500 bushels, from about 15,500 bushels to about 20,500 bushels, from about 20,500 bushels to about 25,000 bushels, from about 25,000 bushels to about 30,000 bushels, from about 30,000 bushels to about 42,000 bushels, from about 42,000 bushels to about 55,000 bushels, or from about 55,000 bushels to about 71,000 bushels. Accordingly, a length and/or a number of augers may be adjusted based on a number of bushels the grain bin is capable of storing or a volume of the grain bin in which the auger(s) are to be installed. For example, a number of augers installed in a bin may be an auger, one or more augers, more than one auger, or a plurality of augers. Further for example, a number of augers installed in a bin may be about one auger to about five augers, about five augers to about 10 augers, about 10 augers to about 25 augers, about 25 augers to about 50 augers, about 50 augers to about 100 augers, or greater than 100 augers may be installed on various portions of an inner sidewall of a bin.

Some embodiments, as shown in FIG. 1, of a system for reducing grain bin entrapment may include an optional control circuitry 110 for activating and deactivating the power source 130. The activated power source 130 causes the auger 150 to convey material from a bottom portion 250 of the bin to a top portion 260 of the bin 100 (shown in FIG. 2). The control circuitry 110 may include a processor and/or functional circuitry (e.g., a timing circuit) to control activation of the power source 130.

In some embodiments, as shown in FIG. 1, of a system for reducing grain bin entrapment includes an optional control circuitry 110 (e.g., including a processor) electrically coupled to memory storing instructions and an optional antenna 120. The optional control circuitry 110 (e.g., including a processor) can receive information, data, or inputs, via antenna 120, from the optional computing device 160 and/or transmit or output information or data, via antenna 120, to the optional computing device 160. The optional computing device 160 may be a workstation, a desktop computer, a laptop, a server, a mobile computing device, a wearable device, and the like. For example, in some embodiments, the power source 130 may be electrically coupled to the optional control circuitry 110 (e.g., including a processor). Upon the optional control circuitry 110 (e.g., including a processor) receiving, via optional antenna 120, an input (e.g., audio, text, selection or activation of a user input element on a display of a computing device, etc.) from the optional computing device 160, the optional control circuitry 110 (e.g., including a processor) may execute instructions stored in the memory including: activating the power source 130. The activated power source 130 causes the auger 150 to convey material from a bottom portion 250 of the bin to a top portion 260 of the bin 100 (shown in FIG. 2). The auger 150 may be activated during bin loading, bin unloading, intermittently (e.g., every other day, once a week, once a month, biweekly, etc.), or any point during the storage of materials. One or more optional sensors 180 (e.g., humidity sensors, moisture sensors, or the like) may be used to measure moisture levels within the bin 100 (e.g., at or near the sidewall 270 shown in FIG. 2). If measured moisture levels are greater than a predetermined level, the optional control circuitry 110 (e.g., including a processor) may execute instructions stored in the memory including: activating the power source 130. Alternatively, or additionally, upon the optional control circuitry 110 (e.g., including a processor) receiving, via optional antenna 120, an input from the optional computing device 160, the optional control circuitry 110 (e.g., including a processor) may execute instructions stored in memory including automatically deactivating the power source 130, for example when a bin is substantially empty, during bin loading, during bin unloading, and the like. One or more optional sensors 180 (e.g., ultrasonic distance sensors, or the like) may be used to measure the level of the of grain or contents within the bin 100. The optional control circuitry 110 (e.g., including a processor) may execute instructions stored in memory including automatically deactivating the power source 130 if the level of grain or contents are less than a predetermined amount. The deactivated power source 130 may stop transmitting power to the auger 150, such that the auger 150 stops conveying material from a bottom portion 250 of the bin to a top portion 260 of the bin 100 (shown in FIG. 2).

In some embodiments of a system for reducing grain bin entrapment, as shown in FIG. 1, includes an optional control circuitry 110 (e.g., including a timing circuit) and one or more additional hardware (e.g., relays, solenoid switches, h-bridges, etc.). For example, timing circuits are electronic circuits that generate precise and controlled time intervals or delays. Timing circuits typically include components such as resistors, capacitors, oscillators and/or timers to provide accurate timing for, for example, the timing of cyclical auger actuation events. For example, a timing circuit may be used to activate one or more augers intermittently (e.g., every other day, once a week, once a month, biweekly, etc.) by electronically communicating power from the power source 130 to the auger 150. Some embodiments may include a timing circuit and other control hardware for activation and/or deactivation of the auger 150. For example, local inputs (e.g., buttons, switches, etc.) may be used for control inputs, for example to activate and deactivate the auger 150. Control inputs may be used to initialize an on-cycle for the auger 150. Said another way, a control input (e.g., a button) may be used to start the auger 150 and the timing circuit may maintain the auger 150 in the on-state for a pre-determined amount of time (e.g., . . . ) before deactivating the auger 150 autonomously. Additionally, or alternatively, some embodiments may utilize an antenna 120 as an activation and/or deactivation control input. For example, a remote signal may be sent from a wireless transmitter and received by the antenna 120 as a signal to start or stop the auger 150. Once again, the control input (i.e., remote signal) received by the antenna 120 may be used to start the auger 150 and the timing circuit may maintain the auger 150 in the on-state for a pre-determined amount of time (e.g., 30 seconds, 1 minute, 10 minutes, etc.) before deactivating the auger 150 autonomously.

Embodiments described herein may be used in conjunction with systems known in the art for the reduction of bin contents sticking to the sidewall of bins. For example, embodiments may be used with shakers (e.g., vibrational mechanisms to shake contents and sidewalls), fluffers (e.g., forced ventilation devices), or the like.

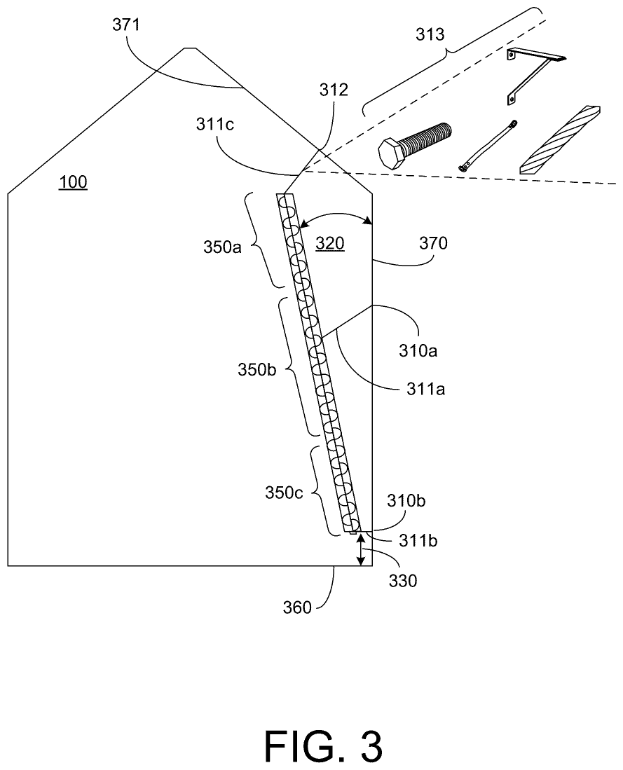

FIG. 3 shows an embodiment of a device for reducing entrapment, installed in the bin. One or more augers or auger portions 350a, 350b, 350c are installed in bin 100. For example, there may be one, 1 to 2, 1 to 5, 5 to 10, 2 to 3, etc. installed augers or auger portions. In embodiments having two or more augers or auger portions, the augers or auger portions may be modular and/or matingly connected, for example via one or more splines, latches, screw connections, or the like. As shown in FIG. 3, the one or more augers or auger portions 350a, 350b, 350c are coupled to at least a portion of an inner sidewall 370 of the bin 100. For example, the one or more augers or auger portions 350a, 350b, 350c may be coupled to the bin 100 on at least a first portion 310a (e.g., a top portion) of sidewall 370. In some variations, the one or more augers or auger portions 350a, 350b, 350c may be coupled to the bin 100 on at least a first portion 310a (e.g., a top portion) of sidewall 370 via coupling element 311a attached to middle auger or middle auger portion 350b and on at least a second portion 310b (e.g., a bottom portion) of sidewall 370 via coupling element 311b attached to the lower auger or auger portion 350c. Additionally, the one or more auger portions 350a, 350b, 350c may be coupled to the bin 100 at least a first portion 312 of the ceiling 371 of the bin 100 by coupling element 311c attached to the upper auger or auger portion 350a. Attachment points may be at any portion of the sidewall 370 or the ceiling 371. Although three attachment points to sidewall portions 310a, 310b and ceiling portion 312 are shown, one of skill in the art will appreciate that any number of attachment points may be used, for example one, more than one, one or more, a plurality of attachment points. Further for example, one to two, one to three, one to five, five to ten, etc. attachment points may be used with respective coupling elements. Exemplary, non-limiting coupling elements include cables, mounting brackets, metal straps, bolts, supports, and the like.

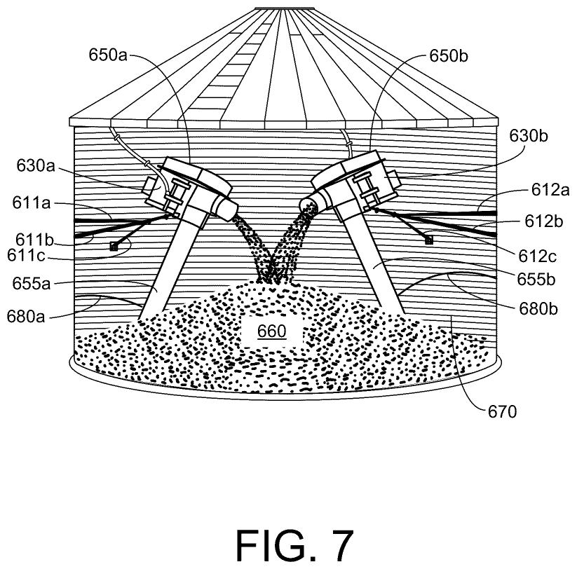

FIG. 7 illustrates a grain bin 100 including a first auger assembly 650a and a second auger assembly 650b. Both auger assemblies 650a, 650b are attached to the inner sidewall 670 of the grain bin 100 by a lower coupling clement (not shown) and an upper coupling element. The upper coupling element of the first auger assembly 650a includes a first cable 611a, a second cable 611b, and a third cable 611c, with each cable attached to a respective portion of an upper portion of the sidewall 670. The cables 611a, 611b, 611c are radially separated such that the upper coupling element provides support and stability to the first auger assembly 650a as the first auger assembly 650a is leaned away from the inner sidewall 670 by angle 680a. Angle 680a may be about 10 degrees to about 40 degrees, about 10 degrees to about 30 degrees, about 13 degrees to about 20 degrees, about 15 degrees to about 20 degrees, about 13 degrees to about 18 degrees, and the like. The upper coupling element of the second auger assembly 650b includes a first cable 612a, a second cable 612b, and a third cable 612c, with each cable attached to a respective portion of an upper portion of the sidewall 670. The cables 612a, 612b, 612c are radially separated such that the upper coupling element provides support and stability to the second auger assembly 650b as the second auger assembly 650b is leaned away from the inner sidewall 670 by angle 680b. Angle 680b may be about 10 degrees to about 40 degrees, about 10 degrees to about 30 degrees, about 13 degrees to about 20 degrees, about 15 degrees to about 20 degrees, about 13 degrees to about 18 degrees, and the like. Auger assembly 650a includes a power source 630a, which may be an electric motor coupled to the auger within auger housing 655a by a belt. Auger assembly 650b includes a power source 630b, which may be an electric motor coupled to the auger within auger housing 655b by a belt. With the auger assemblies 650a, 650b angled toward the center of the bin 100, when powered by respective power sources 630a, 630b, the respective augers of auger assemblies 650a, 650b convey grain 660 from the bottom portion of the bin 100 near the bottom portion of the sidewall 670 (e.g., area 104 shown FIG. 6) toward the center of the grain bin 100 (e.g., into the cone area 106 shown in FIG. 6). As such, the grain 660 volume is circulated and conveyed to an advantageous position (e.g., cone area 106 shown in FIG. 6) for unloading.

In some aspects, the one or more augers or auger portions 350a, 350b, 350c may be offset 330 from a floor 360 of bin 100. For example, the offset 330 may be about 6 inches (0.1524 m) to about 10 feet (3.048 m), about 1 foot (0.308 m) to about 3 feet (0.9144 m), about 1 foot (0.308 m) to about 2 feet (0.6096 m), about 1 foot (0.308 m) to about 5 feet (1.524 m), about 5 feet (1.524 m) to about 10 feet (3.048 m), etc. The offset 330 may, for example, prevent the augers or auger portions 350a, 350b, 350c from interfering with other equipment installed in the bin 100, for example sweep augers.

In some aspects, one or more of the augers or auger portions are at least partially encased in or surrounded by a housing or a casing. Augers encased in or surrounded by a housing or casing can convey matter within the housing or casing from a first area to a second area. For example, matter enters the input of the auger housing at a first area (e.g., bottom portion of the bin), is conveyed through the housing of the auger, and exits the auger housing in a second area (e.g., top portion of the bin). The housing may be coupled to a sidewall 370 of the bin 100 by, for example, a cable. The housing or casing (or the augers or auger portions) may be at least partially vibrated by the power source, powering the auger(s) to help break grain crust and also be able to adjust angle 320. In some aspects, one or more augers or auger portions 350a, 350b, 350c may be angled, shown by angle 320, relative to a sidewall 370 of the bin 100. For example, the angle may be about 10 degrees to about 40degrees, about 10 degrees to about 30 degrees, about 13 degrees to about 20 degrees, about 15 degrees to about 20 degrees, about 13 degrees to about 18 degrees, and the like. Angling the auger portions 350a, 350b, 350c, relative to a sidewall 370 of the bin 100 may transfer the material gathered from the bottom portion of the bin 100 closer to the center of the bin 100. Transferring material closer to the center of the bin 100 may improve unloading capacity, which typically is performed from the bottom-center of the bin 100, and to further move grain away from a sidewall to aerate the material and reduce molding and sticking.

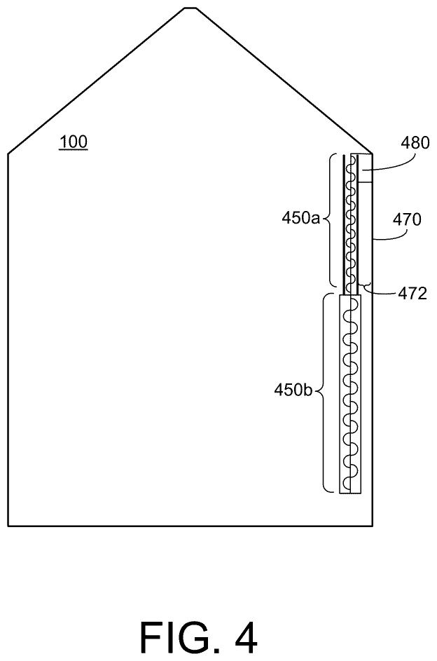

FIG. 4 shows an embodiment of a device for reducing bin entrapment. As described elsewhere herein, one or more augers or auger portions 450a, 450b are coupled to one or more portions of a sidewall 470 of bin 100. Power source 480 powers the one or more augers or auger portions 450a, 450b. Also as described elsewhere herein, the one or more augers or auger portions may be offset from a floor of bin 100. In one non-limiting example, for a bin having a height of 46 feet (14.0208 m), a bottom portion (e.g., auger 450b) of an auger assembly would be about 25 feet (7.62 m) in height and a top portion (e.g., auger 450a) would be about 21 feet (6.4008 m). Although augers of example lengths are described herein, any number of auger portions of any number of lengths can be used herein to span a vertical height of a bin of interest. Further, in any of the embodiments described herein, augers of any range of diameters may be used, for example 4 inches (10.16 cm) to about 20 inches (50.8 cm), about 4 inches (10.16 cm) to about 10 inches (25.4 cm), about 4 inches (10.16 cm) to about 8 inches (20.32 cm), etc. In embodiments having two or more augers, the augers may or may not be the same or substantially the same length and/or may or may not be the same or substantially the same diameter.

In some implementations, the one or more augers, auger portions, or auger assembly is offset 472 from a vertical inner sidewall 470 of the bin. For example, the offset may be about 3 inches (7.62 cm) to about 3 feet (0.9144 m); about 3 inches (7.62 cm) to about 1 foot (0.3048 m); about 6 inches (15.24 cm) to about 1 foot (0.3048 m); etc.

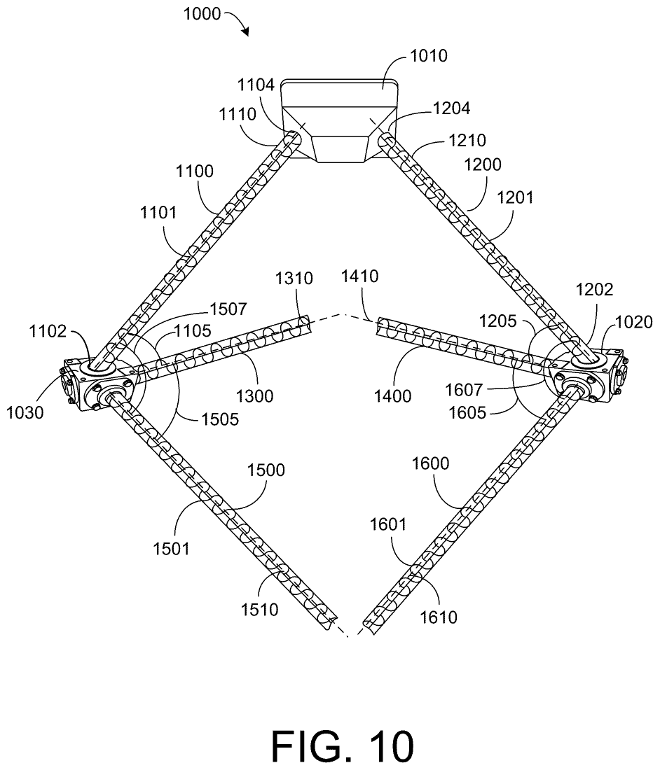

FIG. 10 illustrates an example of a system 1000 for reducing bin entrapment. The system 1000 may include a casing 1100 housing an auger 1101, a casing 1300 housing an auger 1301, an optional casing 1500 housing an auger 1501, an optional casing 1200 housing an auger 1201, an optional casing 1400 housing an auger 1401, and an optional casing 1600 housing an auger 1601. In some embodiments, the system 1000 may include a gathering bin 1010 coupled to the casing 1100 and the casing 1200, such that material conveyed via the auger 1101 and the auger 1201 is input into the gathering bin 1010. The system 1000 may include a gearbox 1030 for torsionally locking the auger 1101 and the auger 1301, and, optionally, the auger 1501, such that torque may be transferred from the auger 1101 to the auger 1301 and optionally the auger 1501. The system 1000 may further include a second gearbox 1020 for torsionally locking the auger 1201, the auger 1401, and auger 1601, such that torque may be transferred from the auger 1201 to the auger 1401 and the auger 1601. The casing 1300, the casing 1500, the casing 1400, and the casing 1600 may be trough casings (i.e., approximately half of a cylindrical casing) or be perforated casings, such that material (e.g., grain) may be conveyed from any point near each respective auger. For example, material may be conveyed from any point along the longitudinal axis 1310 of the auger 1301. Material may be conveyed from any point along the longitudinal axis 1510 of the auger 1501. Material may be conveyed from any point along the longitudinal axis 1410 of the auger 1401. Material may be conveyed from any point along the longitudinal axis 1610 of the auger 1601. Activation of the system 1000 may drive, for example, auger 1101 to rotate auger 1301 and auger 1501, and may drive auger 1201 to rotate auger 1401 and auger 1601. When rotated, auger 1301 and auger 1501 convey material to the first end 1102 of the casing 1100. When rotated, auger 1101 conveys material from the first end 1102 of the casing 1100 to the second end 1104 of the casing 1100, such that the material is input into the gathering bin 1010. When rotated, auger 1401 and auger 1601 convey material to the first end 1202 of the casing 1200. When rotated, the auger 1201 conveys material from the first end 1202 of the casing 1200 to the second end 1204 of the casing 1200, such that the material is input into the gathering bin 1010.

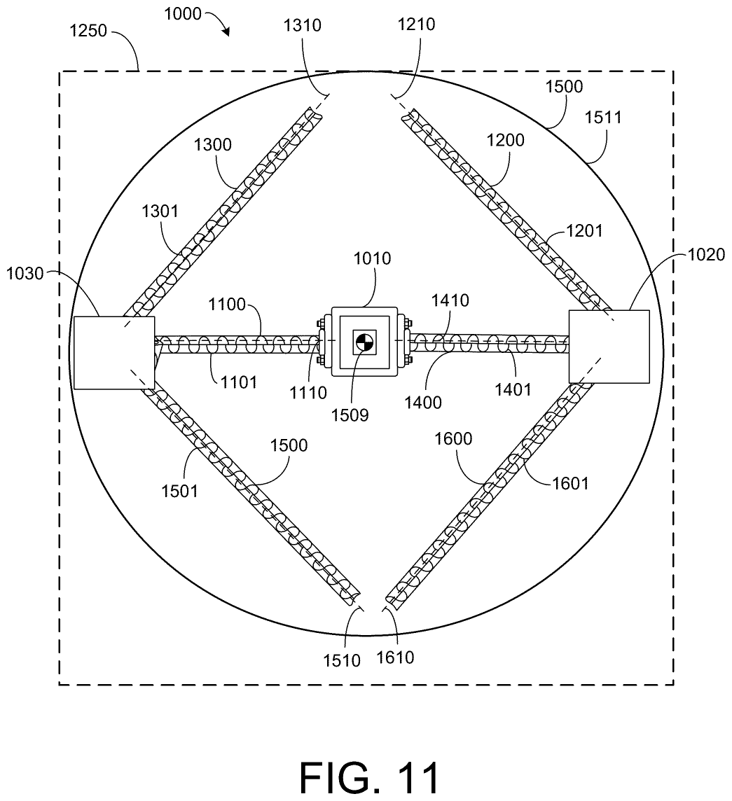

In some embodiments, the system 1000 may be rigidly constructed such that the longitudinal axis 1110 of the casing 1100 and the longitudinal axis 1210 of the casing 1200 may be supported substantially perpendicular to one or more of: the longitudinal axis 1310 of the auger 1301, the longitudinal axis 1510 of the auger 1501, the longitudinal axis 1410 of the auger 1401, and the longitudinal axis 1610 of the auger 1601, as shown. Substantially perpendicular is defined herein as differing by an angle (e.g., angles 1105, 1205, 1507, 1607) greater than about 45 degrees and less than or equal to about 135 degrees, with some embodiments ranging from less than about 90 degrees and greater than about 45 degrees. In some embodiments, the longitudinal axis 1110 of the auger 1101 and the longitudinal axis 1210 of the auger 1201 both extend from a bottom portion 250 (shown in FIG. 2) of a grain bin to a top portion 260 (shown in FIG. 2) of a grain bin. In some embodiments, the longitudinal axis 1110 of the auger 1101 and the longitudinal axis 1210 of the auger 1201 may angle toward the centroid 1509 of the grain bin 1505 (shown in FIG. 11). One or more of the longitudinal axis 1310 of the auger 1301, the longitudinal axis 1510 of the auger 1501, the longitudinal axis 1410 of the auger 1401, and the longitudinal axis 1610 of the auger 1601 may be substantially coplanar. For example, one or more of longitudinal axes 1310, 1410, 1510, and 1610 may be approximately coplanar within plane 1250. For example, when the system 1000 is installed in a grain bin, plane 1250 may be approximately parallel to the grain bin floor 360, shown in FIG. 3. In some embodiments, one or more of: angle 1105 between the longitudinal axis 1310 of the auger 1301 and the longitudinal axis 1110 of the auger 1101, angle 1205 between the longitudinal axis 1410 of the auger 1401 and the longitudinal axis 1210 of the auger 1201, angle 1507 between the longitudinal axis 1510 of the auger 1501 and the longitudinal axis 1110 of the auger 1101, and angle 1607 between the longitudinal axis 1610 of the auger 1601 and the longitudinal axis 1210 of the auger 1201 may be approximately equal.

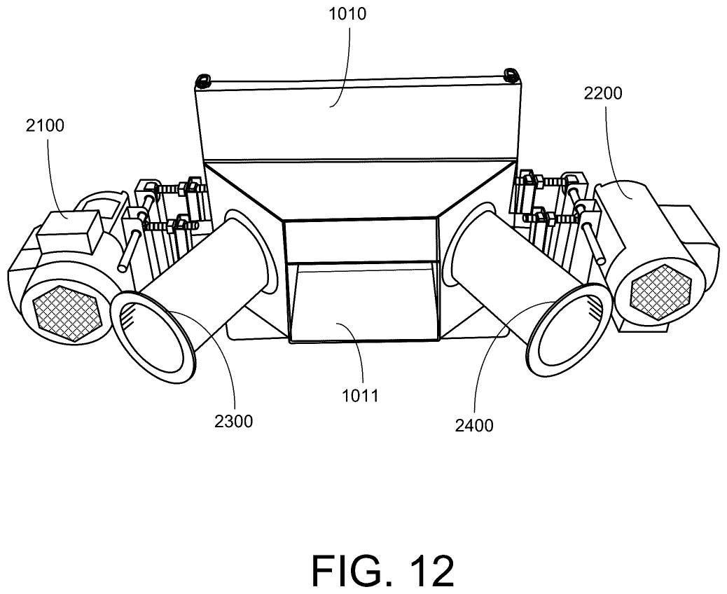

FIG. 12 illustrates a gathering bin 1010. The gathering bin 1010 includes a flange 2300 for coupling the gathering bin 1010 to the casing 1100, and a flange 2400 for coupling the gathering bin 1010 to the casing 1200. Further, the gathering bin 1010 may include a motor 2100, acting as a power source, that may be operatively coupled to the auger 1101 to drive the auger 1101 and, thus, the auger 1301 and the auger 1501. Further, the gathering bin 1010 may include a second motor 2200, acting as a power source, operatively coupled to the auger 1201 to drive the auger 1201 and, thus, the auger 1401 and the auger 1601. When driven to rotate, the auger 1101 and the auger 1201 convey material into the gathering bin 1010, which is directed through an aperture 1011 defined by the gathering bin 1010. The grain bin may be located centrally within the grain bin 1505 and underneath the center hatch, such that material loaded into the grain bin may be directed into the gathering bin 1010 and through the defined aperture 1011.

FIG. 11 illustrates a top perspective view of the system 1000 within a grain bin 1505. One or more of the casings 1300, 1400, 1500 and 1600 may be located proximal to the sidewall 1511 of the grain bin 1505. As such, the gearbox 1030 and the gearbox 1020 are located closer to the sidewall 1511 of the grain bin 1505 than the centroid 1509 of the grain bin 1505. In some embodiments, the casings 1300, 1400, 1500 and 1600 form a substantially square shape (i.e., angles 1505 and 1605 being approximately 90 degrees). In such embodiments, and shown in FIG. 11, the square shape formed by the system 1000 may be substantially inscribed (i.e., square is inscribed in a circle if all four corners of the square lie on the circle, the diagonal of an inscribed square is equal to the diameter of the circle and the diameter of the circle also divides the square into two equal right triangles) by the circular shape of the grain bin 1505, when viewed from a top perspective view. With one or more of the casing 1300, the casing 1500, the casing 1400, and the casing 1600 may be located proximal to the sidewall 1511 of the grain bin 1505, a large portion of the volume of material located next to the sidewall 1511 may be circulated to the top portion of the grain bin 1505. Alternatively, if system 1000 were installed within a square or rectangular grain bin, the square or rectangular shape formed by the system 1000 may be substantially concentric with respect to the square or rectangular footprint of the grain bin, when viewed from a top perspective view.

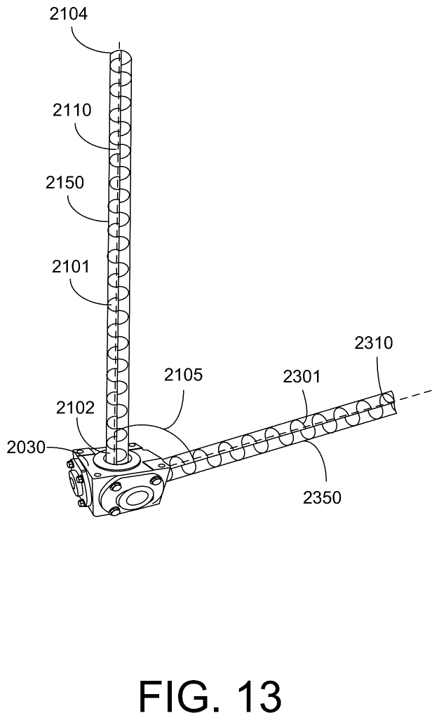

FIG. 13 illustrates an embodiment of a system 2000 for reducing grain bin entrapment. The system 2000 include a casing 2150 housing an auger 2101, and a casing 2350 housing an auger 2301, The system 2000 may include a gearbox 2030 for torsionally locking the auger 2101 and the auger 2301, such that torque may be transferred from the auger 2101 to the auger 2301. Casing 2350 may be trough casings (i.e., approximately half of a cylindrical casing) or be perforated casings, such that material (e.g., grain) may be conveyed from any point near auger 2301. For example, when installed in a grain bin, the longitudinal axis 2310 of auger 2301 may be approximately planar with respect to plane 1250 (shown in FIG. 11), and, thus, approximately parallel to the grain bin floor 360, shown in FIG. 3. The longitudinal axis 2110 of auger 2101 may be substantially perpendicular to the longitudinal axis 2310 of auger 2301. Substantially perpendicular is defined herein as differing by an angle 2105 greater than about 45 degrees and less than or equal to about 135degrees, with some embodiments ranging from less than about 90 degrees and greater than about 45 degrees. For example, when installed in a grain bin, the longitudinal axis 2110 of auger 2101 may extend from a bottom portion 250 (shown in FIG. 2) of a grain bin to a top portion 260 (shown in FIG. 2) of a grain bin. The system 2000 may include a power source, such as electric motor, operatively coupled to auger 2101. When the power source is activated, the power source may drive auger 2101 and, thus, auger 2301. When rotated, auger 2301 may convey material to a first end 2102 of auger 2101 and auger 2101 may convey material from a bottom portion 250 (shown in FIG. 2) of a grain bin to a top portion 260 (shown in FIG. 2) of a grain bin. The described system 2000 may circulate a larger volume compared to an independent auger gathering material from a bottom portion of a grain bin and conveying the material to a top portion of a grain bin.

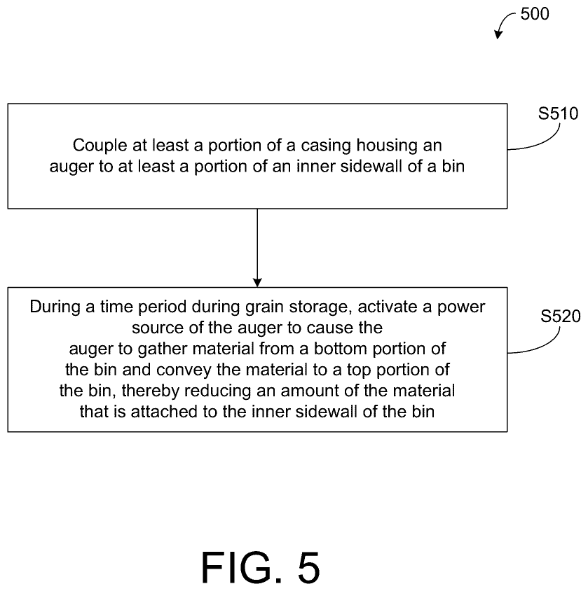

FIG. 5 shows a method 500 of reducing grain bin entrapment. The method 500 can include coupling at least a portion of a casing housing an auger to at least a portion of an inner sidewall of a bin at block S510; and during a time period during grain storage, activating a power source of the auger to cause the auger to gather material from a bottom portion of the bin and convey the material to a top portion of the bin, thereby reducing an amount of the material that is attached to the inner sidewall of the bin at block S520. The method 500 functions to one or more of: circulate material in the bin, increase drying of material in the bin, reduce sticking or attachment of the material to an inner sidewall of the bin, improve loading of material into the bin, improve unloading of material from the bin, and the like.

In some embodiments, the method 500 at step S510 includes coupling the casing to at least the portion of the inner sidewall of the bin via a coupling element. The coupling element may include is one or more bolts, one or more straps, adhesives, welding, one or more rivets, one or more metal clips, and the like.

In some embodiments, the method 500 at step S520 includes, during a time period during grain storage, activating a power source of the auger to cause the auger to gather material from a bottom portion of the bin and convey the material to a top portion of the bin, thereby reducing an amount of the material that is attached to the inner sidewall of the bin. In some embodiments, activating the power source includes activating the power source while the grain is being loaded into the grain bin. Activating the power source, ultimately activating the auger, may allow for increased distribution of incoming contents. In some embodiments, activating includes activating the power source while the grain is being unloaded from the grain bin. In some embodiments, activating includes activating the power source intermittently (e.g., every other day, once a week, once a month, biweekly, etc.).

In some embodiments, the method 500 further includes determining a volume of the bin or a number of bushels the bin can store; and coupling one or more additional casings housing one or more additional augers to another portion of the inner sidewall of the grain bin.

In some embodiments, the method 500 further includes automatically deactivating the power source of the auger.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor in or proximate to the bin and/or on the computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

### EXAMPLES

Example 1. A system for reducing grain attachment to a sidewall of a grain bin, comprising: a first casing housing a first auger, wherein a longitudinal axis of the first auger is configured to be positioned substantially parallel to a floor of the grain bin and offset from the floor of the grain bin, wherein the first casing is a trough casing or a perforated casing; a second casing housing a second auger, wherein a longitudinal axis of the second auger is configured to be positioned substantially perpendicular to the longitudinal axis of the first auger; and a first gearbox operatively coupled to the first auger and the second auger, torsionally locking the first auger and the second auger to one another, wherein the first gearbox is configured to be positioned closer to the sidewall of the grain bin than a centroid of the grain bin, wherein the first auger is configured to convey grain along the longitudinal axis of the first auger to the second auger, and wherein the second auger is configured to convey grain from the first auger to a top portion of the grain bin along the longitudinal axis of the second auger.

Example 2. The system of any one of the preceding examples, but particularly example 1, wherein the second auger is configured to be angled toward the centroid of the grain bin.

Example 3. The system of any one of the preceding examples, but particularly example 2, further comprising a gathering bin coupled to the second auger in an upper portion of the grain bin such that the grain conveyed by the second auger is input into the gathering bin.

Example 4. The system of any one of the preceding examples, but particularly example 3, further comprising a third auger casing housing a third auger coupled to the gathering bin, wherein the third auger is configured to extend from the gathering bin in the top portion of the grain bin toward the sidewall of the grain bin in a bottom portion of the grain bin.

Example 5. The system of any one of the preceding examples, but particularly example 4, further comprising a fourth casing housing a fourth auger wherein a longitudinal axis of the fourth auger is configured to be positioned substantially parallel to the floor of the grain bin and offset from the floor of the grain bin, wherein the fourth casing is a trough casing or a perforated casing, wherein the fourth auger is torsionally locked with the third auger.

Example 6. The system of any one of the preceding examples, but particularly example 5, further comprising a second gearbox configured to torsionally lock the third auger and the fourth auger to one another.

Example 7. The system of any one of the preceding examples, but particularly example 1, further comprising control circuitry including a timing circuit to intermittently activate a power source to activate each auger.

Example 8. The system of any one of the preceding examples, but particularly example 1, further comprising an antenna configured to receive a remote signal to activate a power source to activate each auger.

Example 9. The system of any one of the preceding examples, but particularly example 1, further comprising control circuitry including a processor electrically coupled to memory, and a power source, wherein the processor is configured to execute instructions stored in the memory, the instructions comprising: based on at least one of: an input, or a predetermined time delay, automatically activating or deactivating the power source to activate or deactivate each auger.

Example 10. The system of any one of the preceding examples, but particularly example 9, further comprising an antenna electrically coupled to the processor, wherein the processor further comprises receiving, via the antenna, the input.

Example 11. The system of any one of the preceding examples, but particularly example 10, further comprising a computing device, wherein the input received by the processor is from the computing device.

Example 12. A system for reducing grain attachment to a sidewall of a grain bin, comprising: a first casing housing a first auger, wherein a longitudinal axis of the first auger is configured to be positioned substantially parallel to a floor of the grain bin and offset from the floor of the grain bin, wherein the first casing is a trough casing or a perforated casing; a second casing housing a second auger, wherein a longitudinal axis of the second auger is configured to be positioned substantially parallel to a floor of the grain bin and offset from the floor of the grain bin, wherein the second casing is a trough casing or a perforated casing, wherein the first auger and the second auger are separated by a first angle; a third casing housing a third auger, wherein a longitudinal axis of the third auger is configured to be positioned substantially perpendicular to the longitudinal axis of the first auger and the longitudinal axis of the second auger; and a first gearbox operatively coupled to the first auger, the second auger, and the third auger, wherein the first, second, and third augers are torsionally locked to one another, wherein the first auger and the second auger are configured to convey grain along the longitudinal axis of the first auger and the longitudinal axis of the second auger, respectively, to the third auger, and wherein the third auger is configured to convey grain from the first auger and the second auger to a top portion of the grain bin along the longitudinal axis of the third auger.

Example 13. The system of any one of the preceding examples, but particularly example 12, wherein the third auger extends from the first gearbox and is configured to be angled toward a centroid of the grain bin and an upper portion of the grain bin.

Example 14. The system of any one of the preceding examples, but particularly example 13, further comprising a gathering bin coupled to the third casing in the upper portion of the grain bin such that the grain conveyed by the third auger is input into the gathering bin.

Example 15. The system of any one of the preceding examples, but particularly example 14, further comprising: a fourth casing housing a fourth auger, wherein a longitudinal axis of the fourth auger is configured to be positioned substantially parallel to the floor of the grain bin and offset from the floor of the grain bin, wherein the fourth casing is a trough casing or a perforated casing; a fifth casing housing a fifth auger, wherein a longitudinal axis of the fifth auger is configured to be positioned substantially parallel to the floor of the grain bin and offset from the floor of the grain bin, wherein the first casing is a trough casing or a perforated casing, wherein the fourth casing and the fifth casing are separated by a second angle; a sixth casing housing a sixth auger, wherein a longitudinal axis of the sixth auger is configured to be positioned substantially perpendicular to the longitudinal axis of the fourth auger and the longitudinal axis of the sixth auger, wherein the sixth casing is configured to be angled toward the centroid of the grain bin, and coupled to the gathering bin; and a second gearbox operatively coupled to the fourth auger, the fifth auger, and the sixth auger, thus torsionally locking the fourth auger, the fifth auger, and the sixth auger to one another, wherein the fourth auger and the fifth auger are configured to convey the grain along the longitudinal axis of the fourth auger and the longitudinal axis of the fifth auger, respectively, to the sixth auger, and wherein the sixth auger is configured to convey the grain from the fourth auger and the fifth auger to the gathering bin.

Example 16. A method of reducing grain attachment to a sidewall of a grain bin, comprising: positioning a first gearbox closer to the sidewall of the grain bin than to a centroid of the grain bin; operatively coupling a first auger housed within a first casing to the first gearbox, wherein a longitudinal axis of the first auger is positioned substantially parallel to a floor of the grain bin and offset from the floor of the grain bin, wherein the first casing is a trough casing or a perforated casing; operatively coupling a second auger housed within a second casing to the first gearbox, wherein a longitudinal axis of the second auger is configured to be positioned substantially perpendicular to the longitudinal axis of the first auger, wherein the longitudinal axis of the second auger is configured to extend from a bottom portion of the grain bin to a top portion of the grain bin; and providing a power source that, when activated, is configured to rotate the first auger and the second auger that is torsionally locked to the first auger via the first gearbox; wherein the grain is configured to be conveyed along the longitudinal axis of the first auger to the second auger, and conveyed by the second auger from the bottom portion of the grain bin to the top portion of the grain bin.

Example 17. The method of any one of the preceding examples, but particularly example 16, further comprising coupling a gathering bin to the second casing in an upper portion of the grain bin such that grain conveyed by the second auger is input into the gathering bin, wherein the longitudinal axis of the second auger is angled toward the centroid of the grain bin.

Example 18. The method of any one of the preceding examples, but particularly example 17, further comprising: positioning a second gearbox closer to the sidewall of the grain bin than to a center of the grain bin; operatively coupling a third auger housed within a third casing to the second gearbox, wherein a longitudinal axis of the third auger is positioned substantially parallel to the floor of the grain bin and offset from the floor of the grain bin, wherein the third casing is a trough casing or a perforated casing; and operatively coupling a fourth auger housed within a fourth casing to the second gearbox, wherein a longitudinal axis of the fourth auger is configured to be positioned substantially perpendicular to the longitudinal axis of the third auger, wherein the longitudinal axis of the second auger is configured to extend from a bottom portion of the grain bin to the top portion of the grain bin and angle toward the centroid of the grain bin, and wherein when the power source is activated, is configured to rotate the third auger and the fourth auger that is torsionally locked to the third auger via the second gearbox.

Example 19. The method of any one of the preceding examples, but particularly example 16, further comprising operatively coupling a third auger housed within a third casing to the first gearbox torsionally locking the third auger to the first auger and the second auger, wherein a longitudinal axis of the third auger is positioned substantially parallel to the floor of the grain bin and offset from the floor of the grain bin, wherein the third casing is a trough casing or a perforated casing, wherein the third auger is configured to convey grain along the longitudinal axis of the third auger to the second auger.

Example 20. The method of any one of the preceding examples, but particularly example 18, further comprising: operatively coupling a fifth auger housed within a fifth casing to the first gearbox torsionally locking the fifth auger to the first auger and the second auger, wherein a longitudinal axis of the fifth auger is positioned substantially parallel to the floor of the grain bin and offset from the floor of the grain bin, wherein the fifth casing is a trough casing or a perforated casing; and operatively coupling a sixth auger housed within a sixth casing to the second gearbox torsionally locking the sixth auger to the third auger and the fourth auger, wherein a longitudinal axis of the sixth auger is positioned substantially parallel to the floor of the grain bin and offset from the floor of the grain bin, wherein the sixth casing is a trough casing or a perforated casing.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “auger” may include, and is contemplated to include, a plurality of augers. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for reducing grain attachment to a sidewall of a grain bin, comprising:
a first casing housing a first auger, wherein a longitudinal axis of the first auger is configured to be positioned substantially parallel to a floor of the grain bin and offset from the floor of the grain bin, wherein the first casing is a trough casing or a perforated casing;
a second casing housing a second auger, wherein a longitudinal axis of the second auger is configured to be positioned substantially perpendicular to the longitudinal axis of the first auger; and
a first gearbox operatively coupled to the first auger and the second auger, torsionally locking the first auger and the second auger to one another, wherein the first gearbox is configured to be positioned closer to the sidewall of the grain bin than a centroid of the grain bin,
wherein the first auger is configured to convey grain along the longitudinal axis of the first auger to the second auger, and
wherein the second auger is configured to convey grain from the first auger to a top portion of the grain bin along the longitudinal axis of the second auger.

2. The system of claim 1, wherein the second auger is configured to be angled toward the centroid of the grain bin.

3. The system of claim 2, further comprising a gathering bin coupled to the second auger in an upper portion of the grain bin such that the grain conveyed by the second auger is input into the gathering bin.

4. The system of claim 3, further comprising a third auger casing housing a third auger coupled to the gathering bin, wherein the third auger is configured to extend from the gathering bin in the top portion of the grain bin toward the sidewall of the grain bin in a bottom portion of the grain bin.

5. The system of claim 4, further comprising a fourth casing housing a fourth auger wherein a longitudinal axis of the fourth auger is configured to be positioned substantially parallel to the floor of the grain bin and offset from the floor of the grain bin, wherein the fourth casing is a trough casing or a perforated casing, wherein the fourth auger is torsionally locked with the third auger.

6. The system of claim 5, further comprising a second gearbox configured to torsionally lock the third auger and the fourth auger to one another.

7. The system of claim 1, further comprising control circuitry including a timing circuit to intermittently activate a power source to activate each auger.

8. The system of claim 1, further comprising an antenna configured to receive a remote signal to activate a power source to activate each auger.

9. The system of claim 1, further comprising control circuitry including a processor electrically coupled to memory, and a power source, wherein the processor is configured to execute instructions stored in the memory, the instructions comprising:
based on at least one of: an input, or a predetermined time delay, automatically activating or deactivating the power source to activate or deactivate each auger.

10. The system of claim 9, further comprising an antenna electrically coupled to the processor, wherein the processor further comprises receiving, via the antenna, the input.

11. The system of claim 10, further comprising a computing device, wherein the input received by the processor is from the computing device.

12. A system for reducing grain attachment to a sidewall of a grain bin, comprising:
a first casing housing a first auger, wherein a longitudinal axis of the first auger is configured to be positioned substantially parallel to a floor of the grain bin and offset from the floor of the grain bin, wherein the first casing is a trough casing or a perforated casing;
a second casing housing a second auger, wherein a longitudinal axis of the second auger is configured to be positioned substantially parallel to a floor of the grain bin and offset from the floor of the grain bin, wherein the second casing is a trough casing or a perforated casing, wherein the first auger and the second auger are separated by a first angle;
a third casing housing a third auger, wherein a longitudinal axis of the third auger is configured to be positioned substantially perpendicular to the longitudinal axis of the first auger and the longitudinal axis of the second auger; and
a first gearbox operatively coupled to the first auger, the second auger, and the third auger, wherein the first, second, and third augers are torsionally locked to one another,
wherein the first auger and the second auger are configured to convey grain along the longitudinal axis of the first auger and the longitudinal axis of the second auger, respectively, to the third auger, and
wherein the third auger is configured to convey grain from the first auger and the second auger to a top portion of the grain bin along the longitudinal axis of the third auger.

13. The system of claim 12, wherein the third auger extends from the first gearbox and is configured to be angled toward a centroid of the grain bin and an upper portion of the grain bin.

14. The system of claim 13, further comprising a gathering bin coupled to the third casing in the upper portion of the grain bin such that the grain conveyed by the third auger is input into the gathering bin.

15. The system of claim 14, further comprising:
a fourth casing housing a fourth auger, wherein a longitudinal axis of the fourth auger is configured to be positioned substantially parallel to the floor of the grain bin and offset from the floor of the grain bin, wherein the fourth casing is a trough casing or a perforated casing;
a fifth casing housing a fifth auger, wherein a longitudinal axis of the fifth auger is configured to be positioned substantially parallel to the floor of the grain bin and offset from the floor of the grain bin, wherein the first casing is a trough casing or a perforated casing, wherein the fourth casing and the fifth casing are separated by a second angle;
a sixth casing housing a sixth auger, wherein a longitudinal axis of the sixth auger is configured to be positioned substantially perpendicular to the longitudinal axis of the fourth auger and the longitudinal axis of the sixth auger, wherein the sixth casing is configured to be angled toward the centroid of the grain bin, and coupled to the gathering bin; and
a second gearbox operatively coupled to the fourth auger, the fifth auger, and the sixth auger, thus torsionally locking the fourth auger, the fifth auger, and the sixth auger to one another,
wherein the fourth auger and the fifth auger are configured to convey the grain along the longitudinal axis of the fourth auger and the longitudinal axis of the fifth auger, respectively, to the sixth auger, and
wherein the sixth auger is configured to convey the grain from the fourth auger and the fifth auger to the gathering bin.

16. A method of reducing grain attachment to a sidewall of a grain bin, comprising:
positioning a first gearbox closer to the sidewall of the grain bin than to a centroid of the grain bin;
operatively coupling a first auger housed within a first casing to the first gearbox, wherein a longitudinal axis of the first auger is positioned substantially parallel to a floor of the grain bin and offset from the floor of the grain bin, wherein the first casing is a trough casing or a perforated casing;
operatively coupling a second auger housed within a second casing to the first gearbox, wherein a longitudinal axis of the second auger is configured to be positioned substantially perpendicular to the longitudinal axis of the first auger, wherein the longitudinal axis of the second auger is configured to extend from a bottom portion of the grain bin to a top portion of the grain bin; and
providing a power source that, when activated, is configured to rotate the first auger and the second auger that is torsionally locked to the first auger via the first gearbox;
wherein the grain is configured to be conveyed along the longitudinal axis of the first auger to the second auger, and conveyed by the second auger from the bottom portion of the grain bin to the top portion of the grain bin.

17. The method of claim 16, further comprising coupling a gathering bin to the second casing in an upper portion of the grain bin such that grain conveyed by the second auger is input into the gathering bin, wherein the longitudinal axis of the second auger is angled toward the centroid of the grain bin.

18. The method of claim 17, further comprising:
positioning a second gearbox closer to the sidewall of the grain bin than to a center of the grain bin;
operatively coupling a third auger housed within a third casing to the second gearbox, wherein a longitudinal axis of the third auger is positioned substantially parallel to the floor of the grain bin and offset from the floor of the grain bin, wherein the third casing is a trough casing or a perforated casing; and
operatively coupling a fourth auger housed within a fourth casing to the second gearbox, wherein a longitudinal axis of the fourth auger is configured to be positioned substantially perpendicular to the longitudinal axis of the third auger, wherein the longitudinal axis of the second auger is configured to extend from a bottom portion of the grain bin to the top portion of the grain bin and angle toward the centroid of the grain bin, and
wherein when the power source is activated, is configured to rotate the third auger and the fourth auger that is torsionally locked to the third auger via the second gearbox.

19. The method of claim 16, further comprising operatively coupling a third auger housed within a third casing to the first gearbox torsionally locking the third auger to the first auger and the second auger, wherein a longitudinal axis of the third auger is positioned substantially parallel to the floor of the grain bin and offset from the floor of the grain bin, wherein the third casing is a trough casing or a perforated casing, wherein the third auger is configured to convey grain along the longitudinal axis of the third auger to the second auger.

20. The method of claim 18, further comprising:
operatively coupling a fifth auger housed within a fifth casing to the first gearbox torsionally locking the fifth auger to the first auger and the second auger, wherein a longitudinal axis of the fifth auger is positioned substantially parallel to the floor of the grain bin and offset from the floor of the grain bin, wherein the fifth casing is a trough casing or a perforated casing; and
operatively coupling a sixth auger housed within a sixth casing to the second gearbox torsionally locking the sixth auger to the third auger and the fourth auger, wherein a longitudinal axis of the sixth auger is positioned substantially parallel to the floor of the grain bin and offset from the floor of the grain bin, wherein the sixth casing is a trough casing or a perforated casing.
